(19) United States
(12) Patent Application Publication
(10) Pub. No.: US 2019/0378355 A1
(43) Pub. Date: Dec. 12, 2019

(54) REMOTE VEHICLE ELECTRONICS CONFIGURATION

(71) Applicant: GM GLOBAL TECHNOLOGY OPERATIONS LLC, Detroit, MI (US)

(72) Inventors: Frank R. Bruneel, II, Clinton Township, MI (US); Markus Jochim, Troy, MI (US); David D. Malkan, Troy, MI (US); Douglas C. Martin, Goodrich, MI (US)

(21) Appl. No.: 16/006,329

(22) Filed: Jun. 12, 2018

(51) Int. Cl. G07C 5/00; G06F 21/62

(52) U.S. Cl. CPC G07C 5/008; H04L 67/12; G06F 21/6245

(57) ABSTRACT

A system and method of remotely configuring vehicle electronics of one or more vehicles, wherein the vehicle electronics includes one or more onboard vehicle sensors. The method includes: receiving a vehicle sensor data request from a vehicle sensor data requestor, wherein the vehicle sensor data request includes a request to obtain vehicle sensor data from a set of vehicles according to one or more vehicle sensor request options; generating a non-vehicle-specific sensor configuration request based on the one or more vehicle sensor request options; generating one or more vehicle-specific sensor configuration requests based on the non-vehicle-specific sensor configuration request, wherein each of the one or more vehicle-specific sensor configuration requests is associated with a particular vehicle electronics configuration type; and sending each of the one or more vehicle-specific sensor configuration requests to one or more vehicles of the set of vehicles based on the associated particular vehicle electronics configuration type.

### INTRODUCTION

The present invention relates to configuring vehicle electronics of various architectures.

Vehicles include hardware and software capable of obtaining and processing various information, including information that is obtained by vehicle system modules (VSMs). Moreover, vehicles include networking capabilities and can be connected to various vehicle backend servers. Vehicle information can be reported to a remote facility using such networking capabilities. Moreover, commands and messages can be generated and sent to the vehicle from a remote facility to request vehicle information.

### SUMMARY

According to one aspect of the invention, there is provided a method of remotely configuring vehicle electronics of one or more vehicles, wherein the vehicle electronics includes one or more onboard vehicle sensors, the method including: receiving a vehicle sensor data request from a vehicle sensor data requestor, wherein the vehicle sensor data request includes a request to obtain vehicle sensor data from a set of vehicles according to one or more vehicle sensor request options; generating a non-vehicle-specific sensor configuration request based on the one or more vehicle sensor request options; generating one or more vehicle-specific sensor configuration requests based on the non-vehicle-specific sensor configuration request, wherein each of the one or more vehicle-specific sensor configuration requests is associated with a particular vehicle electronics configuration type; and sending each of the one or more vehicle-specific sensor configuration requests to one or more vehicles of the set of vehicles based on the particular vehicle electronics configuration type associated with each of the one or more vehicle-specific sensor configuration requests, wherein each of the one or more vehicles are configured to: receive at least one of the vehicle-specific sensor configuration requests; compile vehicle sensor data from one or more onboard vehicle sensors in response to receiving the at least one vehicle-specific sensor configuration request and based on the at least one vehicle-specific sensor configuration request; and send the compiled vehicle sensor data to a remote computer or remote facility.

According to various embodiments, this method may further include any one of the following features or any technically-feasible combination of some or all of these features:
the method is carried out using at least one computer program executing on at least one server located at a remote facility, and wherein the at least one computer program is stored on a non-transitory computer readable medium;
the vehicle data requestor is a computer that is located remotely from the system carrying out the method;
the one or more vehicle-specific sensor configuration requests are generated using vehicle electronics reference information stored in a database, wherein the database associates each of the particular vehicle electronics configuration types with particular vehicle electronics reference information;
the vehicle sensor data request is received at a vehicle data request system, the non-vehicle-specific sensor configuration request is generated at the vehicle data request system, and the vehicle-specific sensor configuration requests are generated at a vehicle backend services server system;
sending the non-vehicle-specific sensor configuration request from the vehicle data request system to the vehicle backend services server system; and receiving the non-vehicle-specific sensor configuration request at the vehicle backend services server system;
the vehicle backend services server system includes a computer program that is configured to carry out the step of generating the one or more vehicle-specific sensor configuration requests and wherein the vehicle data request system includes a separate computer program that is configured to carry out the steps of receiving the vehicle sensor data request and generating the non-vehicle-specific sensor configuration request;
determining whether the vehicle sensor data request complies with a data privacy governance rule-set; and denying the vehicle sensor data request when it is determined that the vehicle sensor data request does not comply with a data privacy governance rule-set;
notifying the vehicle data requestor of the denial or approval of the vehicle sensor data request;
the vehicle sensor data request includes vehicle sensor data request options specifying the set of vehicles;
the vehicle sensor data request options include any one or more of the following: vehicle sensor data type(s), vehicle sensor data source(s), vehicle sensor collection frequency(s), and vehicle condition(s);
evaluating the vehicle sensor data request in conjunction with a plurality of active vehicle sensor configuration settings regarding the set of vehicles, wherein the vehicle sensor configuration settings indicate current settings of the one or more onboard vehicle sensors; and determining redundancies in the vehicle sensor data request with respect to the active vehicle sensor configuration settings and based on the evaluating step; wherein the non-vehicle-specific sensor configuration request is generated based at least partially on the determined redundancies in the vehicle sensor data request;
modified vehicle sensor data request options are included in the non-vehicle-specific sensor configuration request, and wherein the modified vehicle sensor data request options are based on the determined redundancies in the vehicle sensor data request;
the vehicle sensor data request specifies a particular time period for when the configuration of the one or more vehicles is to be effected;
each of the one or more vehicles are further configured to modify operation of at least one of the one or more onboard vehicle sensors in response to the at least one vehicle-specific sensor configuration request;
the at least one vehicle-specific sensor configuration request includes a vehicle electronics configuration script, wherein each of the one or more vehicles are further configured to execute the vehicle electronics configuration script, and wherein the execution of the vehicle electronics configuration script causes the vehicle to carry out the receive, compile, and send steps; and/or
a plurality of vehicle-specific sensor configuration requests are generated based on a single non-vehicle-specific sensor configuration request.

According to another aspect of the invention, there is provided a remote vehicle sensor configuration system including: a first server that includes a processor and computer-readable memory, the computer-readable memory storing a vehicle request handling application; a second server that includes a processor and computer-readable memory, the computer-readable memory storing a remote vehicle configuration application; and a vehicle backend database that stores vehicle electronics reference information, wherein the vehicle electronics reference information is associated with one or more vehicle electronics configuration types; wherein the vehicle request handling application, when executed by the processor of the first server, causes the first server to: receive a vehicle sensor data request from a vehicle sensor data requestor, wherein the vehicle sensor data request includes a request to obtain vehicle sensor data from a set of vehicles according to one or more vehicle sensor request options; generate a non-vehicle-specific sensor configuration request based on the one or more vehicle sensor request options; and send the non-vehicle-specific sensor configuration request to the second server; and wherein the remote vehicle configuration application, when executed by the processor of the second server, causes the second server to: generate one or more vehicle-specific sensor configuration requests in response to receiving and based on the non-vehicle-specific sensor configuration request, wherein each of the one or more vehicle-specific sensor configuration requests is associated with a particular vehicle electronics configuration type, and wherein the vehicle electronics reference information associated with the particular vehicle electronics configuration type is used to generate the one or more vehicle-specific sensor configuration requests for vehicles of the particular vehicle electronics configuration type; and send each of the one or more vehicle-specific sensor configuration requests to one or more vehicles of the set of vehicles based on the particular vehicle electronics configuration type associated with each of the one or more vehicle-specific sensor configuration requests.

According to various embodiments, this method may further include any one of the following features or any technically-feasible combination of some or all of these features:
each of the one or more vehicles are configured to: receive at least one of the vehicle-specific sensor configuration requests; compile vehicle sensor data from one or more onboard vehicle sensors in response to receiving the at least one vehicle-specific sensor configuration request and based on the at least one vehicle-specific sensor configuration request; and send the compiled vehicle sensor data to a remote computer or remote facility; and/or
the vehicle request handling application, when executed by the processor of the first server, further causes the first server to: evaluate the vehicle sensor data request in conjunction with a plurality of active vehicle sensor configuration settings regarding the set of vehicles, wherein the vehicle sensor configuration settings indicate current settings of the one or more onboard vehicle sensors; and determine redundancies in the vehicle sensor data request with respect to the active vehicle sensor configuration settings and based on the evaluating step; wherein the non-vehicle-specific sensor configuration request is generated based at least partially on the determined redundancies in the vehicle sensor data request.

### BRIEF DESCRIPTION OF THE DRAWINGS

One or more embodiments of the invention will hereinafter be described in conjunction with the appended drawings, wherein like designations denote like elements, and wherein:

FIG. 1 is a block diagram depicting an embodiment of a communications system that is capable of utilizing the method disclosed herein;

FIG. 2 is a block diagram depicting an embodiment of a remote vehicle sensor configuration system;

FIG. 3 is a flowchart of an embodiment of a method of remotely configuring vehicle electronics of one or more vehicles;

FIG. 4 is a flowchart of another embodiment of a method of remotely configuring vehicle electronics of one or more vehicles; and

FIG. 5 is a flowchart of yet another embodiment of a method of remotely configuring vehicle electronics of one or more vehicles.

### DETAILED DESCRIPTION

The system and method described below enables a vehicle backend facility to configure a plurality of vehicles based on each vehicle's particular vehicle electronics configuration type. In one embodiment, a remote user or application may desire particular vehicle sensor information from a specified set of vehicles, with each of the specified vehicles having a particular vehicle electronics configuration type some or all of which may be different. A vehicle electronics configuration type refers to a particular configuration of vehicle electronics within a vehicle, including, for example, the particular vehicle system module (VSM) communication architecture or serial data communication architecture. The specified vehicles may include different vehicle electronics configuration types, which can be complex and/or unique per each vehicle electronics configuration type. Therefore, in at least some embodiments, there is provided a system and method that can accept a sensor data request and, from that single data request, automatically generate and distribute various vehicle-specific (e.g., specific to the particular vehicle electronics configuration type) sensor data requests that cause each vehicle to be configured to report sensor information according to the vehicle-specific sensor data request.

In one embodiment, the vehicle-specific sensor data request can be based on a vehicle sensor data request that is independent of any particular vehicle electronics configuration type and that may specify vehicles of differing vehicle electronics configuration types. For example, a single vehicle sensor data request can be used along with vehicle electronics reference information to generate a plurality of vehicle-specific sensor data requests, with each of the vehicle-specific sensor data requests corresponding to a particular vehicle electronics configuration type. Moreover, the vehicle electronics reference information can include information concerning the electronics architecture (e.g., VSM communication architecture, serial data communication architecture) or various vehicles and, also, the vehicle electronics reference information can be associated with a corresponding vehicle electronics configuration type at a database accessible by the systems and/or methods discussed herein. In this way, a user (e.g., vehicle data requestor) may need to generate only a single vehicle sensor data request and, through use of the system(s) and method(s) discussed below, this single vehicle sensor data request can be used to generate a plurality of vehicle-specific sensor data requests that are each usable by a vehicle of a particular vehicle electronics configuration type. Thus, through use of the vehicle electronics reference information, the plurality of vehicle-specific sensor data requests can be generated without placing the burden of understanding the details of each vehicle's particular vehicle electronics configuration on the user. In at least some embodiments, the method(s) and system(s) discussed herein improves vehicle electronics technology by enabling modification of vehicle electronics of a plurality of vehicles in an automated fashion using a remote facility configured in the particular way discussed herein.

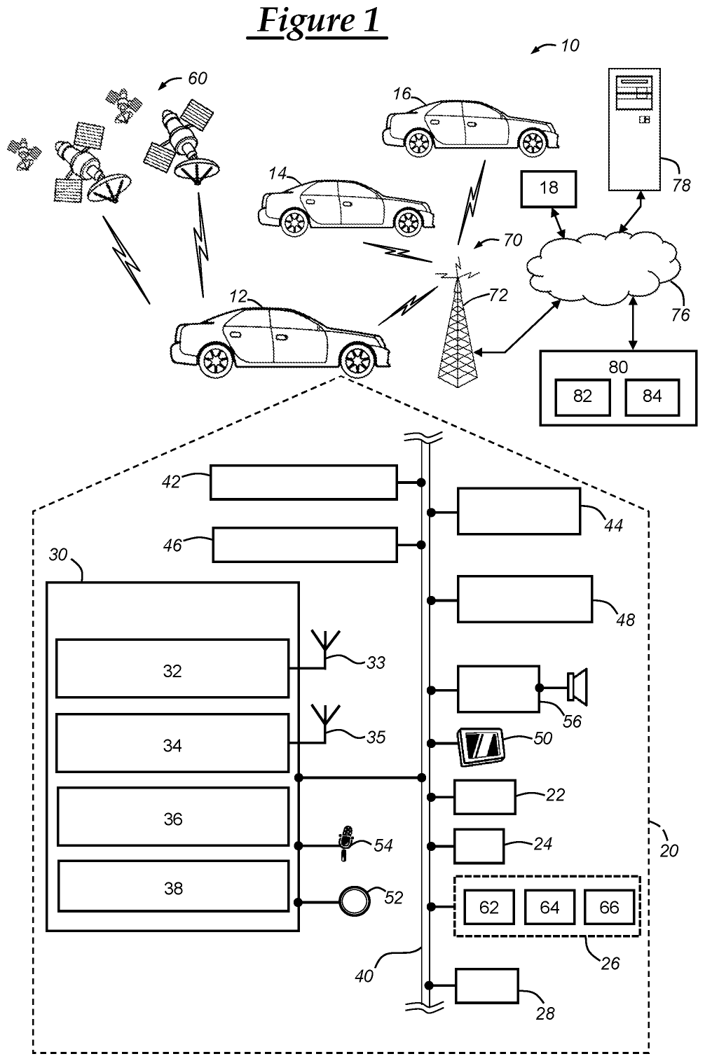

With reference to FIG. 1, there is shown an operating environment that comprises a communications system 10 and that can be used to implement the method disclosed herein. Communications system 10 generally includes a first vehicle 12 with a wireless communications device 30 and other VSMs 22-56, a second vehicle 14, a third vehicle 16, a roadside unit (RSU) 18, a constellation of global navigation satellite system (GNSS) satellites 60, one or more wireless carrier systems 70, a land communications network 76, a computer or server 78, and a vehicle backend services facility 80. It should be understood that the disclosed method can be used with any number of different systems and is not specifically limited to the operating environment shown here. Thus, the following paragraphs simply provide a brief overview of one such communications system 10; however, other systems not shown here could employ the disclosed method as well.

Vehicle 12 is depicted in the illustrated embodiment as a passenger car, but it should be appreciated that any other vehicle including motorcycles, trucks, sports utility vehicles (SUVs), recreational vehicles (RVs), marine vessels, aircraft including unmanned aerial vehicles (UAVs), etc., can also be used. Some of the vehicle electronics 20 are shown generally in FIG. 1 and includes a global navigation satellite system (GNSS) receiver 22, a body control module or unit (BCM) 24, an engine control module (ECM) 26, other vehicle system modules (VSMs) 28, a wireless communications device 30, battery sensor(s) 42, movement sensor(s) 44, vision sensor(s) 46, exhaust sensor(s) 48, and vehicle-user interfaces 50-56. Some or all of the different vehicle electronics may be connected for communication with each other via one or more communication busses, such as communications bus 40. The communications bus 40 provides the vehicle electronics with network connections using one or more network protocols and can use a serial data communication architecture. Examples of suitable network connections include a controller area network (CAN), a media oriented system transfer (MOST), a local interconnection network (LIN), a local area network (LAN), and other appropriate connections such as Ethernet or others that conform with known ISO, SAE, and IEEE standards and specifications, to name but a few.

The vehicle 12 can include numerous vehicle system modules (VSMs) as part of vehicle electronics 20, such as the GNSS receiver 22, BCM 24, ECM 26, wireless communications device 30, battery sensor(s) 42, movement sensor(s) 44, vision sensor(s) 46, exhaust sensor(s) 48, and vehicle-user interfaces 50-56, as will be described in detail below. The vehicle 12 can also include other VSMs 28 in the form of electronic hardware components that are located throughout the vehicle and, which may receive input from one or more sensors and use the sensed input to perform diagnostic, monitoring, control, reporting, and/or other functions. Each of the VSMs 28 is preferably connected by communications bus 40 to the other VSMs, as well as to the wireless communications device 30, and can be programmed to run vehicle system and subsystem diagnostic tests. Moreover, each of the VSMs can include and/or be communicatively coupled to suitable hardware that enables intra-vehicle communications to be carried out over the communications bus 40; such hardware can include, for example, bus interface connectors and/or modems. One or more VSMs 28 may periodically or occasionally have their software or firmware updated and, in some embodiments, such vehicle updates may be over the air (OTA) updates that are received from a computer 78 or remote facility 80 via land network 76 and communications device 30. In one embodiment, the OTA updates (or other software/firmware updates) can be particular to the vehicle electronics configuration type of the vehicle 12 and, when installed, can cause the VSM to operate according to instructions received at the vehicle in a vehicle-specific sensor configuration request, as discussed more below. As is appreciated by those skilled in the art, the above-mentioned VSMs are only examples of some of the modules that may be used in vehicle 12, as numerous others are also possible.

Global navigation satellite system (GNSS) receiver 22 receives radio signals from a constellation of GNSS satellites 60. GNSS receiver 22 can be configured to comply with and/or operate according to particular regulations or laws of a given geopolitical region (e.g., country). The GNSS receiver 22 can be configured for use with various GNSS implementations, including global positioning system (GPS) for the United States, BeiDou Navigation Satellite System (BDS) for China, Global Navigation Satellite System (GLONASS) for Russia, Galileo for the European Union, and various other navigation satellite systems. For example, the GNSS receiver 22 may be a GPS receiver, which may receive GPS signals from a constellation of GPS satellites 60. And, in another example, GNSS receiver 22 can be a BDS receiver that receives a plurality of GNSS (or BDS) signals from a constellation of GNSS (or BDS) satellites 60. In either implementation, GNSS receiver 22 can include at least one processor and memory, including a non-transitory computer readable memory storing instructions (software) that are accessible by the processor for carrying out the processing performed by the receiver 22.

GNSS receiver 22 may be used to provide navigation and other position-related services to the vehicle operator. Navigation information can be presented on the display 50 (or other display within the vehicle) or can be presented verbally such as is done when supplying turn-by-turn navigation. The navigation services can be provided using a dedicated in-vehicle navigation module (which can be part of GNSS receiver 22 and/or incorporated as a part of wireless communications device 30 or other VSM), or some or all navigation services can be done via the vehicle communications device (or other telematics-enabled device) installed in the vehicle, wherein the position information is sent to a remote location for purposes of providing the vehicle with navigation maps, map annotations (points of interest, restaurants, etc.), route calculations, and the like. The position information can be supplied to the vehicle backend services facility 80 or other remote computer system, such as computer 78, for other purposes, such as fleet management and/or for use in a car sharing service. Also, new or updated map data can be downloaded to the GNSS receiver 22 from the remote facility 80 via the wireless communications device 30.

Body control module (BCM) 24 can be used to control various VSMs of the vehicle, as well as obtain information concerning the VSMs, including their present state or status, as well as sensor information. The BCM 24 is shown in the exemplary embodiment of FIG. 1 as being electrically coupled to the communication bus 40. In some embodiments, the BCM 24 may be integrated with or part of a center stack module (CSM) and/or integrated with wireless communications device 30. Or, the BCM may be a separate device that is connected to other VSMs via bus 40. The BCM 24 can include a processor and/or memory, which can be similar to processor 36 and memory 38 of wireless communications device 30, as discussed below. The BCM 24 may communicate with wireless device 30 and/or one or more vehicle system modules, such as the engine control module (ECM) 26, battery sensor(s) 42, movement sensor(s) 44, vision sensor(s) 46, exhaust sensor(s) 48, audio system 56, or other VSMs 28. The BCM 24 may include a processor and memory accessible by the processor. Suitable memory may include non-transitory computer-readable memory that includes various forms of RAM and ROM. Software stored in the memory and executable by the processor enables the BCM to direct one or more vehicle functions or operations including, for example, controlling central locking, air conditioning, power mirrors, controlling the vehicle primary mover (e.g., engine, primary propulsion system), and/or controlling various other vehicle modules. For example, the BCM 24 can send signals to other VSMs, such as a request to perform a particular operation or a request for vehicle sensor data and, in response, the sensor may then send back the requested information. And, the BCM 24 may receive vehicle sensor data from VSMs, including battery sensor data or other sensor data from battery sensor(s) 42, movement sensor data from movement sensor 44, spatial or image data from vision sensor(s) 46, exhaust sensor data or other sensor data from exhaust sensor(s) 48, and various other information or data from other VSMs.

Additionally, the BCM 24 may provide vehicle state information corresponding to the vehicle state or of certain vehicle components or systems, including the VSMs discussed herein. For example, the BCM 24 may provide the device 30 with information indicating whether the vehicle's ignition is turned on (as received from ECM 26, for example), the gear the vehicle is presently in (i.e. gear state), and/or other information regarding the vehicle. The vehicle sensor data and/or vehicle operating state information that is received or obtained at the BCM 24 can be used to monitor certain vehicle operations and, in some embodiments, the BCM 24 can be configured to monitor for certain vehicle conditions as specified in the vehicle-specific sensor configuration request that is received from the remote facility 80. This monitoring may be carried out as part of a vehicle monitoring process or diagnostic process and the information can be sent to the wireless communications device 30 (or other central vehicle computer) automatically upon a request from the device/computer, or automatically upon certain conditions being met, such as when the BCM recognizes the occurrence of a vehicle condition. The wireless communications device 30 can then send the vehicle sensor data (and/or other information) to the remote facility 80 via cellular carrier system 70 and/or land network 76.

Engine control module (ECM) 26 may control various aspects of engine operation such as fuel ignition and ignition timing. The ECM 26 is connected to the communications bus 40 and may receive operation instructions (or vehicle commands) from the BCM 24 or other vehicle system modules, such as the wireless communications device 30 or other VSMs 28. In one scenario, the ECM 26 may receive a command from the BCM to start the vehicle—i.e., initiate the vehicle ignition or other primary propulsion system (e.g., a battery powered motor). Moreover, the ECM 26 is an onboard vehicle sensor that can be used to obtain vehicle sensor information of the vehicle engine, such as from engine speed sensor 62, engine temperature sensor 64, and engine ignition timing sensor 66, all of which are also onboard vehicle sensors. In embodiments when the vehicle is a hybrid or electric vehicle, the ECM 26 can be used to obtain status information regarding the primary mover (including electrical motor(s) and battery information).

The vehicle 12 includes various onboard vehicle sensors 42-48 and 62-66, as well as certain vehicle-user interfaces 50-54 that can be utilized as onboard vehicle sensors. Generally, the sensors 42-54 can use their respective sensor (or sensing device) to obtain vehicle sensor data, which can include vehicle sensor values as measured or determined by the onboard vehicle sensor. Other information pertaining to either the operating state of the vehicle (the “vehicle operating state”) or the environment of the vehicle (the “vehicle environmental state”) can also be obtained or may be included in the vehicle sensor data. The vehicle sensor data can be sent to other VSMs, such as BCM 24 and the vehicle communications device 30, via communications bus 40. Also, in some embodiments, the vehicle sensor data can be sent with metadata, which can include data identifying the sensor (or type of sensor) that captured the vehicle sensor data, a timestamp (or other time indicator), and/or other data that pertains to the vehicle sensor data or vehicle sensor. The “vehicle operating state” refers to a state of the vehicle concerning the operation of the vehicle, which can include the operation of the primary mover (e.g., a vehicle engine, vehicle propulsion motors). Additionally, the vehicle operating state can include the vehicle state concerning mechanical operations of the vehicle—that is, the state of the mechanical operations of the vehicle. The “vehicle environmental state” refers to a vehicle state concerning the interior of the cabin and the nearby, exterior area surrounding the vehicle. The vehicle environmental state includes behavior of a driver, operator, or passenger, as well as traffic conditions, roadway conditions and features, and statuses of areas nearby the vehicle.

The battery sensor(s) 42, which can be installed into the vehicle as an onboard vehicle sensor, can include a battery voltage sensor, a battery current sensor, and a battery temperature sensor. The battery voltage sensor can be used to measure the voltage across terminals of a vehicle battery. The battery current sensor can be used to measure current provided by the vehicle battery, and the battery temperature sensor can be used to measure a temperature of the vehicle battery. In one particular embodiment, the battery voltage sensor, the battery current sensor, and the battery temperature sensor can be included in and/or integrated into a single module or sensor unit that is coupled to the battery. The battery sensor(s) 42 can be coupled to various other VSMs directly or via communications bus 40.

The movement sensors 44 can be used to obtain movement or inertial information concerning the vehicle, such as vehicle speed, acceleration, yaw (and yaw rate), pitch, roll, and various other attributes of the vehicle concerning its movement as measured locally through use of onboard vehicle sensors. The movement sensors 44 can be mounted on the vehicle in a variety of locations, such as within an interior vehicle cabin, on a front or back bumper of the vehicle, and/or on the hood of the vehicle 12. The movement sensors 44 can be coupled to various other VSMs directly or via the communications bus 40. Movement sensor data can be obtained and sent to the other VSMs, including BCM 24 and/or wireless communications device 30.

In one embodiment, the movement sensors 44 can include wheel speed sensors, which can be installed into the vehicle as an onboard vehicle sensor. The wheel speed sensors are each coupled to a wheel of the vehicle 12 and that can determine a rotational speed of the respective wheel. The rotational speeds from various wheel speed sensors can then be used to obtain a linear or transverse vehicle speed. Additionally, in some embodiments, the wheel speed sensors can be used to determine acceleration of the vehicle. The wheel speed sensors can include a tachometer that is coupled to a vehicle wheel and/or other rotating member. In some embodiments, wheel speed sensors can be referred to as vehicle speed sensors (VSS) and can be a part of an anti-lock braking (ABS) system of the vehicle 12 and/or an electronic stability control program. As discussed more below, the electronic stability control program can be embodied in a computer program or application that can be stored on a non-transitory, computer-readable memory (such as that which is included in BCM 24 or memory 38). The electronic stability control program can be executed using a processor of BCM 24 (or processor 36 of the wireless communications device 30) and can use various sensor readings or data from a variety of vehicle sensors including sensor data from sensors 42-54 and 62-66.

Additionally, the movement sensors 44 can include one or more inertial sensors, which can be installed into the vehicle as an onboard vehicle sensor. The inertial sensor(s) can be used to obtain sensor information concerning the acceleration and the direction of the acceleration of the vehicle. The inertial sensors can be microelectromechanical systems (MEMS) sensor or accelerometer that obtains inertial information. The inertial sensors can be used to detect collisions based on a detection of a relatively high acceleration. When a collision is detected, information from the inertial sensors used to detect the collision, as well as other information obtained by the inertial sensors, can be sent to the wireless communication module 30 (or other central vehicle computer of the vehicle) and used in determining the quality of care. Additionally, the inertial sensor can be used to detect a high level of acceleration or braking. In one embodiment, the vehicle 12 can include a plurality of inertial sensors located throughout the vehicle. And, in some embodiments, each of the inertial sensors can be a multi-axis accelerometer that can measure acceleration or inertial force along a plurality of axes. The plurality of axes may each be orthogonal or perpendicular to one another and, additionally, one of the axes may run in the direction from the front to the back of the vehicle 12. Other embodiments may employ single-axis accelerometers or a combination of single-and multi-axis accelerometers. Other types of sensors can be used, including other accelerometers, gyroscope sensors, and/or other inertial sensors that are known or that may become known in the art.

The movement sensors 44 can include one or more yaw rate sensors, which can be installed into the vehicle as an onboard vehicle sensor. The yaw rate sensor(s) can obtain vehicle angular velocity information with respect to a vertical axis of the vehicle. The yaw rate sensors can include gyroscopic mechanisms that can determine the yaw rate and/or the slip angle. Various types of yaw rate sensors can be used, including micromechanical yaw rate sensors and piezoelectric yaw rate sensors.

The movement sensors 44 can also include a steering wheel angle sensor, which can be installed into the vehicle as an onboard vehicle sensor. The steering wheel angle sensor is coupled to a steering wheel of vehicle 12 or a component of the steering wheel, including any of those that are a part of the steering column. The steering wheel angle sensor can detect the angle that a steering wheel is rotated, which can correspond to the angle of one or more vehicle wheels with respect to a longitudinal axis of vehicle 12 that runs from the back to the front. Sensor data and/or readings from the steering wheel angle sensor can be used in the electronic stability control program that can be executed on a processor of BCM 24 or processor 36.

And, additionally, the movement sensors 44 can include a throttle position sensor (TPS), which can be installed into the vehicle as an onboard vehicle sensor. The TPS that can be used to determine a position of a throttle device of vehicle 12. For example, the throttle position sensor can be coupled to an electronic throttle body or system that is controlled by an actuator (such as a gas pedal) via a throttle actuation controller. The TPS can measure throttle position in a variety of ways, including through using a pin that rotates according to the throttle position (e.g., the output of the throttle actuation controller) and that reads a voltage through the pin. The voltage through the pin can vary due to the pin's position, which varies the amount of resistance of the circuit and the voltage. This voltage data (or other data derived therefrom) can be sent to BCM 24, which can use such vehicle sensor data as a part of the electronic stability control program, as well as various other programs or applications. The movement sensors 44 can include various other sensors not explicitly mentioned here, including brake pedal position sensors and other sensors contributing to a change in movement (i.e., a change in direction or propulsion, as indicated by a sensor reading of a vehicle operation or as indicated by receiving an input that (typically) results in a change in direction or propulsion).

Vision sensor(s) 46 are each an onboard vehicle sensor and may be any type of sensor that obtains visual or spatial information concerning an area within or surrounding the vehicle 12. For example, the vision sensor(s) 46 can be cameras, radars, lidars, etc. The data obtained by the vision sensor(s) 46 may be sent to another vehicle system module (VSM) such as wireless communications device 30 and/or BCM 24 via communications bus 40. In one embodiment, the vision sensor(s) 46 include an electronic digital camera that is powered through use of a vehicle battery. The electronic digital camera may include a memory device and a processing device to store and/or process data that it captures or otherwise obtains, and can be any suitable camera type (e.g., charge coupled device (CCD), complementary metal oxide semiconductor (CMOS), etc.) with any suitable lens.

The vision sensor(s) 46 can be used to capture photographs, videos, and/or other information pertaining to light, which is collectively referred to herein as vision data and which is a particular type of vehicle sensor data. In one embodiment, the vision data can be image data, which is vision data that can be represented in a pixel array and can be captured using interlacing or progressive scanning techniques, as well as other similar or suitable techniques. The image data can be captured at a set or pre-configured scanning or sampling frequency, and the vision sensor(s) may be configured to obtain image data of a particular resolution. Once the image data is obtained through using the vision sensor(s) 46, the image data (or other vision data) can be processed and then sent to one or more other VSMs, including the wireless communications devices 30 and/or the BCM 24. The vision sensor(s) 46 can include processing capabilities that enable image processing techniques, including object recognition techniques, to be carried out at the vision sensor(s) 46. Or, in other embodiments, the cameras may send raw or formatted image data to another VSM, such as device 30 (or other central vehicle computer), which can then perform the image processing techniques.

The exhaust sensor(s) 48 is an onboard vehicle sensor and may be comprise of various sensors that are used to detect or measure characteristics of exhaust gas generated by the vehicle engine. For example, the exhaust sensor(s) 48 can include at least one oxygen sensor (or lambda sensor) that measures the proportional amount of oxygen in the exhaust. Various other gas detectors or gas ionization detectors can be used to measure the content of other elements or molecules, as well as other properties of the exhaust gas. The exhaust sensor data can be sent to one or more other vehicle modules via communications bus 40.

Additionally, the vehicle 12 can include other sensors not explicitly mentioned above, including parking sensors, lane change and/or blind spot sensors, lane assist sensors, ranging sensors (i.e., sensors used to detect the range between the vehicle and another object, such as through use of radar or lidar), tire-pressure sensors, fluid level sensors (including a fuel level sensor), brake pad wear sensors, V2V communication unit (which may be integrated into the wireless communications device 30, as discussed below), rain or precipitation sensors (e.g., infrared light sensor(s) directed toward the windshield (or other window of the vehicle 12) to detect rain or other precipitation based on the amount of reflected light), and interior or exterior temperature sensors.

Wireless communications device 30 is capable of communicating data via short-range wireless communications (SRWC) and/or via cellular network communications through use of a cellular chipset 34, as depicted in the illustrated embodiment. In one embodiment, the wireless communications device 30 is a central vehicle computer that is used to carry out at least part of the vehicle monitoring process. In the illustrated embodiment, wireless communications device 30 includes an SRWC circuit 32, a cellular chipset 34, a processor 36, memory 38, and antennas 33 and 35. In one embodiment, wireless communications device 30 may be a standalone module or, in other embodiments, device 30 may be incorporated or included as a part of one or more other vehicle system modules, such as a center stack module (CSM), body control module (BCM) 24, an infotainment module, a head unit, and/or a gateway module. In some embodiments, the device 30 can be implemented as an OEM-installed (embedded) or aftermarket device that is installed in the vehicle. In some embodiments, the wireless communications device 30 is a telematics unit (or telematics control unit) that is capable of carrying out cellular communications using one or more cellular carrier systems 70. Or, in other embodiments, a separate telematics unit can be included in the vehicle and communicatively coupled to the wireless communications device 30. The telematics unit can be integrated with the GNSS receiver 22 so that, for example, the GNSS receiver 22 and the wireless communications device (or telematics unit) 30 are directly connected to one another as opposed to being connected via communications bus 40.

In some embodiments, the wireless communications device 30 can be configured to communicate wirelessly according to one or more short-range wireless communications (SRWC) such as any of the Wi-Fi™, WiMAX™, Wi-Fi Direct™, IEEE 802.11p, other vehicle to vehicle (V2V) communication protocols, other IEEE 802.11 protocols, ZigBee™ Bluetooth™, Bluetooth™ Low Energy (BLE), or near field communication (NFC). As used herein, Bluetooth™ refers to any of the Bluetooth™ technologies, such as Bluetooth Low Energy™ (BLE), Bluetooth™ 4.1, Bluetooth™ 4.2, Bluetooth™ 5.0, and other Bluetooth™ technologies that may be developed. As used herein, Wi-Fi™ or Wi-Fi™ technology refers to any of the Wi-Fi™ technologies, such as IEEE 802.11b/g/n/ac or any other IEEE 802.11 technology. The short-range wireless communication (SRWC) circuit 32 enables the wireless communications device 30 to transmit and receive SRWC signals, such as BLE signals. The SRWC circuit 32 may allow the device 30 to connect to another SRWC device, such as the RSU 18 or other vehicles. Additionally, in some embodiments, the wireless communications device may contain a cellular chipset 34 thereby allowing the device to communicate via one or more cellular protocols, such as those used by cellular carrier system 70. In such a case, the wireless communications device becomes user equipment (UE) usable in carrying out cellular communications via cellular carrier system 70.

Wireless communications device 30 may enable vehicle 12 to be in communication with one or more remote networks (e.g., one or more networks at remote facility 80 or computers 78) via packet-switched data communication. This packet-switched data communication may be carried out through use of a non-vehicle wireless access point that is connected to a land network via a router or modem. When used for packet-switched data communication such as TCP/IP, the communications device 30 can be configured with a static IP address or can be set up to automatically receive an assigned IP address from another device on the network such as a router or from a network address server.

Packet-switched data communications may also be carried out via use of a cellular network that may be accessible by the device 30. Communications device 30 may, via cellular chipset 34, communicate data over wireless carrier system 70. In such an embodiment, radio transmissions may be used to establish a communications channel, such as a voice channel and/or a data channel, with wireless carrier system 70 so that voice and/or data transmissions can be sent and received over the channel. Data can be sent either via a data connection, such as via packet data transmission over a data channel, or via a voice channel using techniques known in the art. For combined services that involve both voice communication and data communication, the system can utilize a single call over a voice channel and switch as needed between voice and data transmission over the voice channel, and this can be done using techniques known to those skilled in the art.

Processor 36 can be any type of device capable of processing electronic instructions including microprocessors, microcontrollers, host processors, controllers, vehicle communication processors, and application specific integrated circuits (ASICs). It can be a dedicated processor used only for communications device 30 or can be shared with other vehicle systems. Processor 36 executes various types of digitally-stored instructions, such as software or firmware programs stored in memory 38, which enable the device 30 to provide a wide variety of services. For instance, processor 36 can execute programs or process data to carry out at least a part of the method discussed herein. Memory 38 may be a non-transitory computer-readable medium such as may be implemented using various forms of RAM or ROM, or optical or magnetic medium, or any other electronic computer medium that stores some or all of the software needed to carry out the various external device or VSM functions discussed herein.

The wireless communications device 30 can interface various VSMs of the vehicle 12 with one or more devices external to the vehicle 12, such as one or more networks or systems at remote facility 80. This enables various vehicle operations to be carried out and/or monitored by “extra-vehicle” devices (or non-vehicle devices), including the vehicle backend services facility 80. For example, the wireless communications device 30 can receive vehicle sensor data from one or more onboard vehicle sensors 42-54 and 62-66. Thereafter, the vehicle can send this data (or other data derived from or based on this data) to other devices or networks, including a personal SRWC device and the vehicle backend services facility 80. And, in another embodiment, the wireless communications device 30 can be incorporated with or at least connected to a navigation system that includes geographical map information including geographical roadway map data. The navigation system can be communicatively coupled to the GNSS receiver 22 (either directly or via communications bus 40) and can include an on-board geographical map database that stores local geographical map information.

Vehicle electronics 20 also includes a number of vehicle-user interfaces that provide vehicle occupants with a means of providing and/or receiving information, including visual display 50, pushbutton(s) 52, microphone 54, and audio system 56. As used herein, the term “vehicle-user interface” broadly includes any suitable form of electronic device, including both hardware and software components, which is located on the vehicle and enables a vehicle user to communicate with or through a component of the vehicle. Vehicle-user interfaces 50-54 are also onboard vehicle sensors that can receive input from a user or other sensory information (e.g., monitoring information) and that can obtain vehicle sensor data for use in various embodiments of the method(s) below. The pushbutton(s) 52 allow manual user input into the communications device 30 to provide other data, response, and/or control input. Audio system 56 provides audio output to a vehicle occupant and can be a dedicated, stand-alone system or part of the primary vehicle audio system. According to the particular embodiment shown here, audio system 56 is operatively coupled to both vehicle bus 40 and an entertainment bus (not shown) and can provide AM, FM and satellite radio, CD, DVD and other multimedia functionality. This functionality can be provided in conjunction with or independent of an infotainment module. Microphone 54 provides audio input to the wireless communications device 30 to enable the driver or other occupant to provide voice commands and/or carry out hands-free calling via the wireless carrier system 70. For this purpose, it can be connected to an on-board automated voice processing unit utilizing human-machine interface (HMI) technology known in the art. Additionally, the microphone 54 can be used as a decibel (db) noise level monitor (or sensor) that monitors the noise level in the vehicle. Visual display or touch screen 50 is preferably a graphics display and can be used to provide a multitude of input and output functions. Display 50 can be a touch screen on the instrument panel, a heads-up display reflected off of the windshield, or a projector that can project graphics for viewing by a vehicle occupant. Various other vehicle-user interfaces can also be utilized, as the interfaces of FIG. 1 are only an example of one particular implementation.

Vehicle 14 and vehicle 16 are both depicted in the illustrated embodiment as a passenger car, but it should be appreciated that any other vehicle including motorcycles, trucks, sports utility vehicles (SUVs), recreational vehicles (RVs), marine vessels, aircraft including unmanned aerial vehicles (UAVs), etc., can also be used. Moreover, while the vehicle electronics of the vehicles 14 and 16 are not shown, the vehicles 14 and 16 can each include any one or more VSMs discussed herein, including any or all of those VSMs of the vehicle 12. For purposes of illustration, the vehicle 12 may be said to include a vehicle electronics configuration type A, while the vehicles 14 and 16 may be said to include a vehicle electronics configuration type B.

Wireless carrier system 70 may be any suitable cellular telephone system. Carrier system 70 is shown as including a cellular tower 72; however, the carrier system 70 may include one or more of the following components (e.g., depending on the cellular technology): cellular towers, base transceiver stations, mobile switching centers, base station controllers, evolved nodes (e.g., eNodeBs), mobility management entities (MMEs), serving and PGN gateways, etc., as well as any other networking components required to connect wireless carrier system 70 with the land network 76 or to connect the wireless carrier system with user equipment (UEs, e.g., which can include telematics equipment in vehicles 12, 14, and/or 16). Carrier system 70 can implement any suitable communications technology, including GSM/GPRS technology, CDMA or CDMA2000 technology, LTE technology, etc. In general, wireless carrier systems 70, their components, the arrangement of their components, the interaction between the components, etc. is generally known in the art.

Apart from using wireless carrier system 70, a different wireless carrier system in the form of satellite communication can be used to provide uni-directional or bi-directional communication with a vehicle. This can be done using one or more communication satellites (not shown) and an uplink transmitting station (not shown). Uni-directional communication can be, for example, satellite radio services, wherein programming content (news, music, etc.) is received by the uplink transmitting station, packaged for upload, and then sent to the satellite, which broadcasts the programming to subscribers. Bi-directional communication can be, for example, satellite telephony services using the one or more communication satellites to relay telephone communications between the vehicle 12 (and/or vehicles 14, 16) and the uplink transmitting station. If used, this satellite telephony can be utilized either in addition to or in lieu of wireless carrier system 70.

The system 10 can also include other wireless communication systems that use short-range wireless communication (SRWC) protocols, such as any of the Wi-Fi™, WiMAX™, Wi-Fi Direct™, IEEE 802.11p, WiGig™, other IEEE 802.11 protocols, ZigBee™ Bluetooth™, Bluetooth™ Low Energy (BLE), or near field communication (NFC). In at least one embodiment, the system 10 can include roadside units (RSUs) 18 (only one shown) that include a wireless access point (or SRWC circuit) that operates according to a SRWC protocol. The RSUs 18 can be connected to the land network 76 via a wired connection or via a wireless connection, such as those discussed above with respect to wireless carrier system 70. Also, the RSUs can use the wireless access point to communicate with the wireless communications device 30 of the vehicles 12, 14, and/or 16. In other embodiments, the vehicle can host a wireless access point to which the RSU can connect. Thus, the RSUs 18 can be used to communicate information from the remote facility 80 (or computer 78) to the vehicle and vice versa. Other wireless communications can be used to establish other vehicle to infrastructure (V2I) communication paths.

Land network 76 may be a conventional land-based telecommunications network that is connected to one or more landline telephones and connects wireless carrier system 70 to remote facility 80 (or vehicle backend services server system 110, as discussed below). For example, land network 76 may include a public switched telephone network (PSTN) such as that used to provide hardwired telephony, packet-switched data communications, and the Internet infrastructure. One or more segments of land network 76 could be implemented through the use of a standard wired network, a fiber or other optical network, a cable network, power lines, other wireless networks such as wireless local area networks (WLANs), networks providing broadband wireless access (BWA), or any combination thereof.

The computers 78 (only one shown in FIG. 1) can be used for one or more purposes, such as for providing peer-to-peer (P2P) vehicle sharing services to a plurality of vehicles and other electronic network computing devices, including vehicle 12. The computers 78 can be some of a number of computers accessible via a private or public network such as the Internet. In one embodiment, the computers 78 can be computers operated by vehicle data requestors, which are persons, services, applications, or other entities that desire vehicle data or desire to configure the vehicle electronics in a particular way. The vehicle data requestors can use a vehicle data requestor application, which can be executed on computers 78, that enables the vehicle data requestors to generate one or more vehicle sensor data requests through, for example, inputting vehicle sensor data request parameters.

Other such accessible computers 78 can be, for example: a service center computer where diagnostic information and other vehicle data can be uploaded from the vehicle; a client computer used by the vehicle owner or other subscriber for various purposes, such as accessing and/or receiving vehicle sensor data (or other data), as well as setting up and/or configuring subscriber preferences or controlling vehicle functions; a car sharing server which coordinates registrations from a plurality of users who request to use a vehicle as part of a car sharing service; or a third party repository to or from which vehicle sensor data or other information is provided, whether by communicating with the vehicle 12, remote facility 80, or both. A computer 78 can also be used for providing Internet connectivity such as DNS services or as a network address server that uses DHCP or other suitable protocol to assign an IP address to vehicle 12, vehicle 14, and/or vehicle 16. In one particular embodiment, the computer 78 can be operated by a service technician and can include a vehicle diagnostics application, as well as the vehicle requestor application. The vehicle diagnostics application can include a graphical user interface (GUI) that can be presented on a display connected or a part of the computer 78. The vehicle diagnostics application can present various diagnostic information relating to a fleet of vehicles (including the vehicles 12, 14, and 16). This diagnostic information can include vehicle sensor data, other vehicle data, and a vehicle identifier (e.g., vehicle identification number (VIN)).

Vehicle backend services facility 80 is a remote facility, meaning that it is located at a physical location that is located remotely from vehicle 12. The vehicle backend services facility 80 (or “remote facility 80” for short) may be designed to provide the vehicle electronics 20 with a number of different system back-end functions through use of one or more electronic servers 82, including a vehicle diagnostics application (such as the one discussed above). And, in many embodiments, the remote facility 80 can include vehicle backend servers 110 and vehicle data request servers 130. The vehicle backend services facility 80 includes vehicle backend services servers 82 and databases 84, which may be stored on a plurality of memory devices. Also, remote facility 80 can include one or more switches, one or more live advisors, and/or an automated voice response system (VRS), all of which are known in the art. Vehicle backend services facility 80 may include any or all of these various components and, preferably, each of the various components are coupled to one another via a wired or wireless local area network. Remote facility 80 may receive and transmit data via a modem connected to land network 76. Data transmissions may also be conducted by wireless systems, such as IEEE 802.11x, GPRS, and the like. Those skilled in the art will appreciate that, although only one remote facility 80 and one computer 78 are depicted in the illustrated embodiment, numerous remote facilities 80 and/or computers 78 may be used.

Servers 82 can be computers or other computing devices that include at least one processor and memory. The processors can be any type of device capable of processing electronic instructions including microprocessors, microcontrollers, host processors, controllers, vehicle communication processors, and application specific integrated circuits (ASICs). The processors can be dedicated processors used only for servers 82 or can be shared with other systems. The at least one processor can execute various types of digitally-stored instructions, such as software or firmware, which enable the servers 82 to provide a wide variety of services. For network communications (e.g., intra-network communications, inter-network communications including Internet connections), the servers can include one or more network interface cards (NICs) (including, for example, wireless NICs (WNICs)) that can be used to transport data to and from the computers. These NICs can allow the one or more servers 82 to connect with one another, databases 84, or other networking devices, including routers, modems, and/or switches. In one particular embodiment, the NICs (including WNICs) of servers 82 may allow SRWC connections to be established and/or may include Ethernet (IEEE 802.3) ports to which Ethernet cables may be connected to that can provide for a data connection between two or more devices. Remote facility 80 can include a number of routers, modems, switches, or other network devices that can be used to provide networking capabilities, such as connecting with land network 76 and/or cellular carrier system 70.

Databases 84 can be stored on a plurality of memory, such as a powered temporary memory or any suitable non-transitory, computer-readable medium; these include different types of RAM (random-access memory, including various types of dynamic RAM (DRAM) and static RAM (SRAM)), ROM (read-only memory), solid-state drives (SSDs) (including other solid-state storage such as solid state hybrid drives (SSHDs)), hard disk drives (HDDs), magnetic or optical disc drives, that stores some or all of the software needed to carry out the various external device functions discussed herein. One or more databases at the backend facility 80 can store various information and can include a vehicle sensor information database and other vehicle backend information database(s).

Remote facility 80 can use the information stored in databases 84 to carry out one or more embodiments of the method(s) discussed herein, as well as a vehicle sensor configuration process and various other vehicle backend services functionality. As mentioned above, although only a single vehicle backend services facility 80 is illustrated, numerous vehicle backend services facilities can be used and, in such a case, the functionality of the numerous vehicle backend services facilities can be coordinated so that the vehicle backend services facilities can act as a single backend network or so that the operation of each facility is coordinated with the operation of the other facilities. And, the servers 82 can be used to provide information stored in the databases 84 to various other systems or devices, such as vehicles 12, 14, and/or 16.

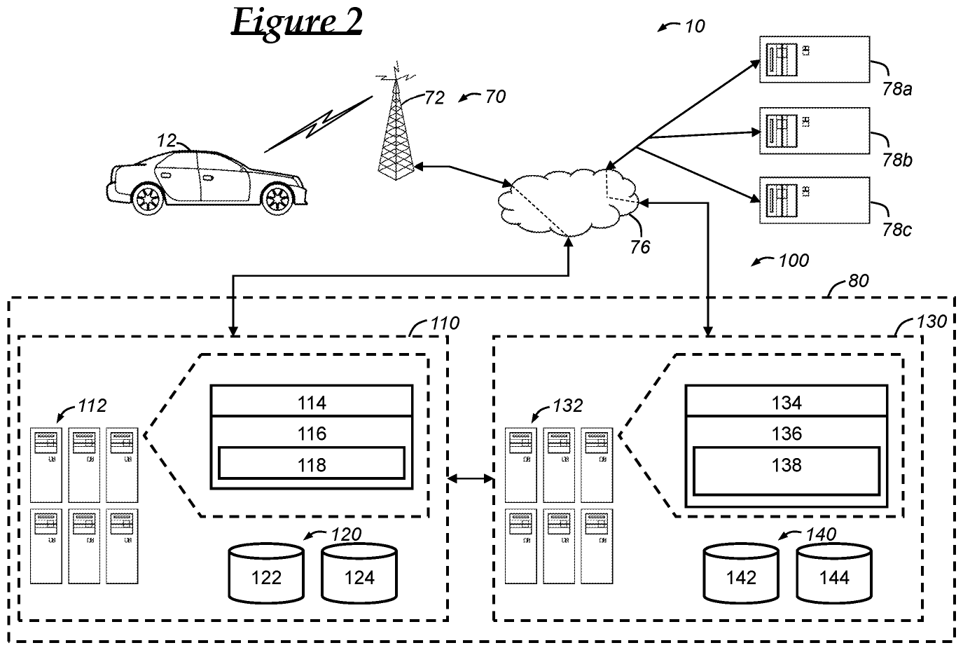

With reference to FIG. 2, there is shown a detailed portion of the communications system 10, including a remote vehicle sensor configuration system 100. The remote vehicle sensor configuration system 100 includes two separate server systems 110 and 130. While FIG. 2 depicts the two separate server systems 110, 130 as being located at a single remote facility 80, in other embodiments, these two separate server systems 110, 130 can be located at different remote facilities 80. Moreover, various instances of the server systems 110, 130 can be deployed to a plurality of remote facilities and, in such case, the operations performed by, and data stored at, each of these facilities can be coordinated across all instances of the server system 110, as well as for the all instances of server system 130.

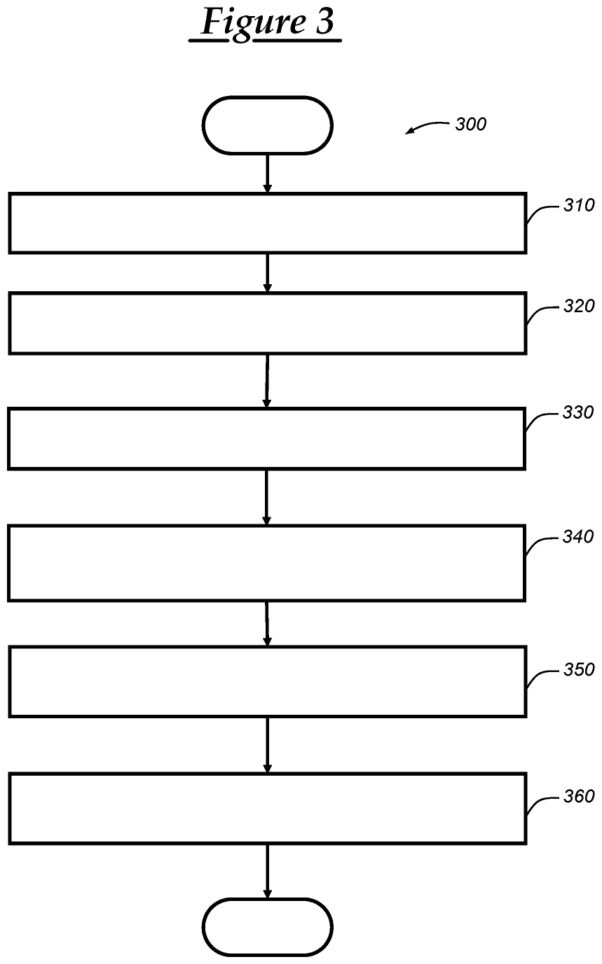

Each of the server systems 110, 130 include one or more servers 112, 132 and one or more databases 120, 140. Each of the one or more servers 112, 132 include a processor 114, 134, memory 116, 136, and an application (or computer program) 118, 138. The servers 112, 132 can include any or all of the features of servers 82 discussed above. The servers 112, 132 can each include NICs or WNICs, such as Ethernet ports (IEEE 802.3) or SRWC circuitry, as well as various other networking interfaces. Moreover, each of the one or more servers 112, 132 of a given system can be interconnected via one or more switches, routers, modems, etc. The memory 116, 136 can be a powered temporary memory or any suitable non-transitory, computer-readable medium; these include different types of RAM (random-access memory, including various types of dynamic RAM (DRAM) and static RAM (SRAM)), ROM (read-only memory), solid-state drives (SSDs) (including other solid-state storage such as solid state hybrid drives (SSHDs)), hard disk drives (HDDs), and/or magnetic or optical disc drives. The memory 116, 136 can store the computer instructions that make up the applications 118, 138 and/or other information for use with applications 118, 138 or other applications. The processors 114, 134 can be any type of device capable of processing electronic instructions including microprocessors, microcontrollers, host processors, controllers, server-grade processors, and application specific integrated circuits (ASICs). The processors 114, 134 can be dedicated processors used only for servers 112, 132 or can be shared with other systems. The one or more processors 114, 134 can execute various types of digitally-stored instructions, such as software or firmware, which enable the servers 112, 132 to provide a wide variety of services, including the vehicle sensor configuration process discussed below, such as that which is described in method 300 (FIG. 3).

Databases 120, 140 can be used to provide information to the servers 112, 132, such as for use in the respective application 118, 138. The databases 120, 140 can include any or all of the features of databases 84 discussed above. In one embodiment, databases 120, 140 can each include or be coupled to dedicated database servers that can implement a database abstraction layer (DBAL) and/or a database management system (DBMS) interface, and that operate to provide information from the databases; in other embodiments, the DBAL or DBMS interface can be implemented on servers 112, 132 using processor 114 (or another processor). The databases 120, 140 can each include one or more databases, such as databases 122, 124, 142, 144 as depicted in FIG. 2. In the case that the databases 120, 140 are carried out on a dedicated database server(s), the dedicated database server(s) can include their own processor, which can include any one or more of those that are discussed with respect to processors 114, 116. Moreover, the dedicated database server(s) can include memory, such as any one or more of those that are discussed with respect to memory 116, 136.

In particular, the server system 110 can be a vehicle backend services server system 110 (or “vehicle backend system 110” for short). The vehicle backend system 110 can include a remote vehicle sensor configuration application 118 that can be stored on memory 116 and executed by processor 114. In addition, the remote vehicle configuration application 118 can be used to generate (or otherwise obtain) a plurality of vehicle-specific sensor configuration requests or signals, which can then be sent to a plurality of vehicles, such as vehicles 12, 14, and 16. These vehicle-specific sensor configuration requests can be generated and/or obtained based on a non-vehicle-specific sensor configuration request that is received from servers system 130 and/or on information stored in databases 120.

Databases 120 can be stored on a plurality of memory, and can include a vehicle electronics reference information database 122 that can store vehicle electronics reference information and a vehicle sensor information database 124 that can store vehicle sensor information (e.g., vehicle sensor data) that is received from one or more vehicles, such as vehicles 12, 14, and/or 16. The vehicle electronics reference information is information that can be used to generate vehicle-specific sensor configuration requests based on non-vehicle-specific sensor configuration requests. The vehicle electronics reference information is information that associates non-vehicle-specific sensor configuration requests to vehicle-specific configuration requests based on the electronics architecture (e.g., VSM communication architecture, serial data communication architecture) such that the vehicle electronics reference information is used to generate vehicle-specific sensor configuration requests from non-vehicle-specific sensor configuration requests. Thus, in one embodiment, the vehicle electronics reference information can include information concerning various vehicle system modules (VSMs) and electronic communication architectures of various vehicles, and which can be organized according to or based on a particular vehicle electronics configuration type. Moreover, the vehicle electronics reference information can be associated with a corresponding vehicle electronics configuration type and, also, this association can be stored in the vehicle electronics reference information database 122 and/or the vehicle sensor information database 124.

In one embodiment, the vehicle electronics reference information database 122 can include vehicle specification information. The vehicle specification information can include information concerning specifications of the vehicle, such as make, model, model-year, standard features (e.g., standard sensors), optional features (e.g., optional sensors), aftermarket features (e.g., aftermarket sensors), vehicle system module (VSM) information (e.g., vehicle sensor and vehicle feature information), vehicle networking information (e.g., networking or user equipment (UE) information, including wireless subscriber information of a telematics unit or other UE, supported networking functionality, device identifiers and/or addresses), VSM communication architecture information, serial data communication architecture information. and various other information pertaining to a particular vehicle, such as the vehicle 12, the vehicle 14, or the vehicle 16. It should be appreciated that any or all of the information stored in the vehicle electronics reference information database 122 can be stored at one or more databases at one or more locations or facilities, and which may be operated and/or managed by one or more associated entities, including an OEM of the vehicles.

The vehicle sensor information database 124 can include a variety of vehicle sensor data from a variety of vehicles. The vehicle sensor information database 124 can include vehicle sensor data and other data concerning the vehicles. The vehicle sensor data can include information received from one or more onboard vehicle sensors of a particular vehicle, such as vehicles 12, 14, and/or 16. The vehicle sensor data can include one or more vehicle sensor values, as well as a time indicator (e.g., timestamp associated with the sensor value), a vehicle identifier (e.g., vehicle identification number (VIN)), etc.

As used herein, a vehicle electronics configuration type is a type of a vehicle electronics architecture and each vehicle electronics configuration type can be used for a plurality of vehicles, such as vehicles that include vehicle electronics with the same or substantially similar architecture and/or the same or substantially similar vehicle system module (VSMs) communication architecture. The VSM communication architecture can include various communication busses that are configured in a particular way, communication protocols that are used to communicate over the various communication busses, and/or communication devices or modules that are used to perform the intra-vehicle communications, such as various modems, each of which can be coupled to a particular VSM or onboard vehicle sensor. In a particular example, the vehicle 12, for example, could include a plurality of data communication busses that use a particular serial data architecture for communications. While this architecture used in vehicle 12 may be the same for other vehicles of the same model-year (i.e., the same model of the same year), other model-years or other models may use a different configuration for their vehicle electronics, communications hardware (e.g., communication busses, modems), and/or different serial data architectures. However, the type of architecture that may be used can depend on a variety of factors. For example, a particular vehicle electronics configuration type may correspond to vehicles of a particular model-year, of a particular group of model-years (e.g., different model-years sharing the same or substantially similar vehicle electronics architecture or configuration), or other suitable classification. Also, as used herein, “vehicle-specific” generally refers to a particular vehicle electronics configuration type whereas “non-vehicle-specific” refers to vehicles in general. A non-vehicle-specific sensor configuration request (or “non-vehicle-specific request” for short) can be a request to obtain vehicle sensor data or other information known or obtained by vehicles in general. And, a vehicle-specific sensor configuration request (or “vehicle-specific request” for short) can be a request that is particularly tailored to effect a configuration of vehicle electronics of a particular vehicle electronics configuration type, which can thereby result in the obtainment of vehicle sensor data in accordance with the particulars (or “vehicle-specific configuration options”) of the vehicle-specific sensor configuration request.

For example, a non-vehicle-specific request can include a request to obtain vehicle speed information from a plurality of vehicles of various vehicle electronics configuration types (e.g., those vehicles as specified in the non-vehicle-specific request), whereas a vehicle-specific request can include a request that is for vehicle speed information and that is particularly tailored according to vehicle electronics reference information concerning a particular vehicle electronics configuration type, such as a request to receive or obtain vehicle speed information that is particularly tailored to be addressed by vehicles of a particular model-year (e.g., 2018 Chevy Cruze®). It should be appreciated that a non-vehicle-specific request can specify one or more particular vehicle electronics configuration types or one or more particular vehicles (or classes thereof), which can be of the same or different vehicle electronics configuration types; nonetheless, the non-vehicle-specific request can still be formed and/or include fields (i.e., portions of data) that are of a generalized or universalized nature and that conveys a request (or command) to configure the specified vehicles in accordance with the generalized or universalized configuration data. The generalized or universalized configuration data, which can comprise one or more fields or portions of the non-vehicle-specific request, can be referred to as non-vehicle-specific configuration data.

The server system 130 can be a vehicle data request system 130 and can include a vehicle request handling application 138 that can be stored on memory 136 and executed by processor 134. The vehicle request handling application 138 can receive one or more vehicle sensor data requests from one or more vehicle sensor data requestors 78a-c. In addition, the vehicle request handling application 138 can be used to generate (or otherwise obtain) one or more non-vehicle-specific sensor configuration signals, which can then be sent to the vehicle backend services server system 110. These non-vehicle-specific sensor configuration signals can be generated and/or obtained based on the vehicle sensor data requests from one or more vehicle sensor data requestors 78a-c.

Vehicle sensor data requestors 78a-c can each be a computer 78, such as client computers (or other electronic computing devices), that can be used to request vehicle sensor information concerning a variety of vehicles. Also, in some embodiments, the vehicle data requestors 78a-c can use a vehicle sensor data requestor application that can provide an interface that allows a vehicle sensor data technician to configure one or more vehicle sensor data requests. The vehicle sensor data requestor application can be stored on memory, such as memory similar to those discussed with respect to memory 116 and 136 but that is included in computers 78a-c. The vehicle sensor data requestor application can be executed by a processor of the vehicle data requestors 78a-c that is operatively coupled to the memory that stores said application; the processor of the requestors 78a-c can be similar or the same as any of those types of processors discussed with respect to processors 114 and/or 134. Moreover, each of the vehicle sensor data requestors 78 can include NIC(s), WNIC(s), and/or other networking interface(s) that can be used to communicate with the vehicle data request system 130, as well as other networked systems and/or computers.

With reference to FIG. 3, there is shown an embodiment of a method 300 of remotely configuring vehicle electronics of one or more vehicles. In one embodiment, the method 300 can be carried out by the vehicle data request system 130 using the servers 132. In a particular embodiment, the method 300 can be executed as a part of the vehicle request handling application 138. In other embodiments, the method 300 can be carried out by the vehicle backend services server system 110, or parts thereof can be carried out by the vehicle data request system 130, the vehicle backend services server system 110, and/or other suitable electronic computing devices or systems. Although the steps of the method 300 are described as being carried out in a particular order, it is hereby contemplated that the steps of the method 300 can be carried out in any suitable order as will be appreciated by those skilled in the art.

The method 300 begins with step 310, wherein a vehicle sensor data request from a vehicle sensor data requestor is received. The vehicle sensor data request can be a request to obtain vehicle sensor data from a set of vehicles according to one or more vehicle sensor request options. The vehicle sensor request options can include one or more vehicle sensor data type(s), vehicle sensor data source(s), vehicle sensor collection frequency(s), vehicle condition(s), and/or identifier(s) for the set of vehicles (e.g., vehicle identification number(s) (VIN(s)), a model-year identifier (i.e., an identifier that uniquely identifies a particular model-year), identifiers of one or more vehicle electronics configuration types). A vehicle sensor data type can specify a type of vehicle sensor data, such as vehicle speed, engine speed, exhaust oxygen content, vision data, vehicle battery information, etc. A vehicle sensor data source can specify a particular type of (or a specific) onboard vehicle sensor, such as a wheel speed sensor, a rear-facing camera, an exhaust oxygen detector, a battery voltage sensor, etc. A vehicle sensor collection frequency can specify a frequency at which the vehicle sensor data should be obtained and can be associated with a particular vehicle sensor data type and/or a particular vehicle sensor data source. A vehicle condition can be a condition corresponding to a vehicle operating state and/or a vehicle environmental state, and can be associated with a particular vehicle sensor data type and/or vehicle sensor data source such that the obtainment of the vehicle sensor data is dependent on whether the vehicle condition is satisfied (or not). For example, the vehicle sensor request options can request vehicle sensor data for vehicle speed (i.e., a vehicle sensor data type) from the front wheel speed sensor (i.e., a vehicle sensor data source) of all 2018 Chevy Cruze® vehicles (i.e., identifier for a set of vehicles) at thirty (30) second intervals (i.e., a vehicle sensor collection frequency) when the vehicle is travelling faster than ten miles per hour (i.e., a vehicle condition and, particularly, a vehicle operating condition) and while the exterior ambient temperature is less than 32° Fahrenheit (i.e., a vehicle condition and, particularly, a vehicle environmental condition). This example will be referenced in the following description as “Example 1.” Also, the vehicle sensor data request need not specify every field in the vehicle sensor request options and, in such a scenario, default values can be used in place of these omitted vehicle sensor request option fields.

In some embodiments, the vehicle sensor request options can include other information or fields, such as a vehicle sensor data configuration period that specifies a period of time in which the vehicle electronics are to be configured and/or operate in accordance with the vehicle sensor request options, such as a period of time in which the vehicle sensor data as specified by the vehicle sensor request options should be obtained. For example, the vehicle sensor data collection period can be specified by a start date and/or time, and an end date and/or time. The vehicle sensor data request may also include other information that can be useful to the vehicle data request system 130, such as an identifier and/or credentials of the vehicle service technician (or other operator of the vehicle sensor data requestor(s) 78a-c), an identifier of a vehicle sensor data usage application that identifies the application that will, or is intending to, use the vehicle sensor data obtained pursuant to the vehicle sensor data request.

In one embodiment, the vehicle sensor data request can be received at the vehicle data request system 130 from the vehicle sensor data requestor 78a-c via land network 76 using remote networking and addressing techniques (e.g., TCP/IP). One or more vehicle service technicians or other users can specify the particular vehicle sensor request options through use of a vehicle sensor data requestor application that is executed by a processor at the vehicle sensor data requestor(s) 78a-c. The vehicle sensor data requestor application can include a graphical user interface (GUI) that can be interacted with by the vehicle service technician via one or more computer-user interface devices, such as a keyboard, mouse, microphone, or other electronic input/output devices or components. Once the vehicle sensor data request is received at the vehicle data request system 130, the method 300 continues to step 320.

In step 320, the vehicle sensor data request is evaluated in conjunction with a plurality of active vehicle sensor configuration settings regarding the set of vehicles. The active vehicle sensor configuration settings indicate current settings of one or more onboard vehicle sensors. The current settings of the one or more onboard vehicle sensors can indicate a vehicle sensor data type(s), vehicle sensor data source(s), vehicle sensor collection frequency(s), and/or vehicle condition(s), any or all of which can be combined or associated with one another in a manner similar to that described above with respect to the vehicle sensor request options. Additionally, each of the active vehicle sensor configuration settings can be associated with a particular vehicle or set of vehicles, which can be specified by one or more vehicle identifier(s) (e.g., vehicle identification number(s) (VIN(s)), a model-year identifier (i.e., an identifier that uniquely identifies a particular model-year), identifiers of one or more vehicle electronics configuration types).

In at least one embodiment, this evaluating step can include determining whether there are redundancies between the vehicle sensor data request and the active vehicle sensor configuration settings. For example, the vehicle sensor request options of the vehicle sensor data request can be compared to the active vehicle sensor configuration settings for the specified set of vehicles (e.g., the set of vehicles specified in the vehicle sensor data request) to determine whether the vehicle is actively (or currently) configured according to the vehicle sensor request options and, if so, to what extent the vehicle is actively (or currently) configured according to the vehicle sensor request options. It should be appreciated that the vehicle may be configured according to the vehicle sensor request options such that the vehicle satisfies the requests made in the vehicle sensor request options; however, the vehicle may be configured in this way due to other requests or commands that are unrelated to the vehicle sensor data request. In this way, a magnitude of impact (or “impact metric”) can be determined for the vehicle sensor data request in light of the active vehicle sensor configuration settings and, in such a case, the impact metric can be used to assess the impact or amount of additional resources that will be needed to carry out the vehicle sensor data request. The impact metric can be associated with a particular vehicle sensor data request and is based on the evaluation of the vehicle sensor data request (including the vehicle sensor data request options) in light of the active vehicle sensor configuration settings and is correlated to the extent of configuration that will be needed to configure the vehicle according to the vehicle sensor request options. The impact metric can be represent or be based on a predicted or estimated amount of transmission costs (e.g., cellular data fees), electricity costs, server costs, database costs, user experience costs, maintenance costs, etc.

In one scenario, the active vehicle sensor configuration settings cover (or encompass) the vehicle sensor data request options for the specified set of vehicles. For example, with reference to Example 1 mentioned above, the active vehicle sensor configuration settings may entirely cover the vehicle sensor data request options of Example 1 where the active vehicle sensor configuration settings indicate that the following data is being collected: vehicle speed data from all wheel speed sensors for all 2018 models is obtained at ten (10) second intervals for all 2018 Chevy® vehicles at all times. In this way, the active vehicle sensor configuration settings entirely cover the vehicle sensor data request options of Example 1. Thus, in the case that the active vehicle sensor configuration settings cover (or encompass) the vehicle sensor data request options for the specified set of vehicles (i.e., the set of vehicles specified in the vehicle sensor data request), the vehicle data requestor can be notified, such as via a notification message that is sent back to the vehicle data requestor via land network 76. The notification message can indicate that the specified set of vehicles are already configured in accordance with the vehicle sensor data request options and, in some embodiments, the notification message can specify a networked location or address where the relevant vehicle sensor data can be obtained, which can be carried out separately or as a part of step 350. In this case, the method 300 can continue to step 340. Moreover, in this case, the impact metric may be very low and/or zero since no new configuration is needed pursuant to the vehicle sensor data request.

In the case that the active vehicle sensor configuration settings do not entirely cover (or encompass) the vehicle sensor data request options for the specified set of vehicles, then the vehicle sensor data request options can be simplified or reduced based on the extent to which the active vehicle sensor configuration settings do not cover the vehicle sensor data request options. This simplified or reduced vehicle sensor data request options can be referred to as the modified vehicle data request options and can include all those configurations needed to place the vehicle in compliance with the vehicle sensor data request provided the active vehicle sensor configuration settings. For example, with respect to Example 1 above, the active vehicle sensor configuration settings may provide that the following data is being collected: vehicle speed data from all wheel speed sensors for all 2018 models is obtained at sixty (60) second intervals for all 2018 Chevy® vehicles when the vehicle is travelling at more than thirty miles per hour. In this example, the active vehicle sensor configuration settings do not entirely cover the vehicle sensor data request options of Example 1 (but do so partially) since the data is not collected at a fast enough interval (once every sixty (60) seconds compared to once every thirty (30) seconds) and the vehicle condition of the active vehicle sensor configuration settings does not encompass the vehicle condition(s) of the vehicle sensor data request options. In such a case, modified vehicle data request options can be generated based on the evaluation of the vehicle sensor data request options in conjunction with the active vehicle sensor configuration settings. In this case, the impact metric may be non-zero and based on the amount of impact due that will result from configuring the specified set of vehicles in accordance with the modified vehicle sensor data request options. The method 300 continues to step 330.

In step 330, it is determined whether the sensor data request complies with a data privacy governance rule-set. The data privacy governance rule-set can include a plurality of rules that can be applied to a vehicle sensor data request so as to indicate whether the vehicle sensor data request complies with certain data privacy rules. For example, the data privacy rules may not permit certain personal identifying information to be accessed or known to the vehicle sensor data requestors (or other entity) and, in such a case, the requested sensor data of the vehicle sensor data request can be evaluated in light of such rules (or data privacy governance rule-set) to determine whether the particular vehicle sensor data request complies with certain data privacy rules. In one scenario, the vehicle sensor data request may request information pertaining to the vehicle's location, as well as information pertaining to the user's identity, such as name and home address. The data privacy governance rule-set can include a rule that evaluates whether the requested information includes the combination of vehicle location and certain user identity fields (e.g., name, home address) and, in such a scenario, the rule, when applied to the vehicle sensor data request, results in a determination that the vehicle sensor data request does not comply with the data privacy governance rule-set. Moreover, the vehicle sensor data request can be modified in response to the evaluation of the vehicle sensor data request and this modified request can be referred to as data privacy-modified vehicle sensor data request. In such a case, the modified vehicle sensor data request can include data privacy-modified vehicle sensor data request options that are the same as the original vehicle sensor data request options with the exception that the modified vehicle sensor data request options do not include one or more data types, data sources, and/or vehicle conditions that are a basis for determining noncompliance of at least a portion of the vehicle sensor data request based on the data privacy governance rule-set. Once it is determined whether the vehicle sensor data request complies with the data privacy governance rule-set, the method 300 continues to step 340.

It should be appreciated that steps 320 and 330 can be carried out in a different order than that which is illustrated in FIG. 3. In one embodiment, step 330 is carried out after step 320 and, in this case, the data privacy governance rule-set may be applied only to the modified vehicle sensor data request options that are obtained as a result of step 320. Additionally, or alternatively, step 320 can be carried out (e.g., again) after step 330 so that an impact metric can be determined for the data privacy-modified vehicle sensor data request options that are a result of step 330.

In step 340, the vehicle sensor data request is approved or denied. In one embodiment, the vehicle sensor data request can be approved or denied based on the determination made in step 320 (impact metric) and/or the determination made in step 330 (compliance with the data privacy governance rule-set). For example, where the impact metric is determined to be above a predetermined (or predefined) impact metric threshold value, then the vehicle sensor data request may be denied and, otherwise, the vehicle sensor data request may be approved. Or, as another example, the vehicle sensor data request may be denied when it is determined that the vehicle sensor data request does not comply with the data privacy governance rule-set. In another embodiment, the vehicle sensor data request (or modified request) can be presented to a vehicle data request system manager. The vehicle data request system manager can be a person that oversees and/or evaluates vehicle sensor data requests. Here, the manager can view the pending vehicle sensor data request and then approve or deny the request. In one embodiment, where the impact metric is above the predetermined impact metric threshold, instead of automatically denying the vehicle sensor data request, the request can be presented to the vehicle data request system manager along with the impact metric and other details so that the manager can make an informed decision regarding approval or denial of the request. Once the vehicle sensor data request is approved or denied, the method 300 continues to step 350.

In step 350, the vehicle sensor data requestor is notified of the approval or denial of the vehicle sensor data request. In one embodiment, a notification message that indicates the approval or denial of the vehicle sensor data request can be sent to the vehicle data requestor 78a-c that submitted the vehicle sensor data request via land network 76. In a particular embodiment, the notification message can indicate one or more reason(s) for denial or approval of the vehicle sensor data request. And, in some embodiments, the notification message can include the modified vehicle sensor data request options that were modified as a result of step 320 and/or step 330 based on, for example, the impact metric and/or the compliance with the data privacy governance rule-set. In this case, the notification message can query (or ask) the vehicle sensor data requestor (or operator/technician thereof) to approve the modified vehicle sensor data request that accompanies the modified vehicle sensor data request options. In the case that the vehicle sensor data requestor approves the modified vehicle sensor data request, the method 300 continues to step 360. When the request is denied and the vehicle sensor data requestor has been notified that the request is denied, the method 300 then ends. In other cases, such as when the vehicle sensor data request is approved, the method 300 continues to step 360.

In step 360, a non-vehicle-specific sensor configuration request is sent to the vehicle backend services server system. In some embodiments, the non-vehicle-specific sensor configuration request can be the vehicle sensor data request or the modified vehicle sensor data request, including the modified vehicle sensor data request options. In other embodiments, the vehicle sensor data request (or the modified vehicle sensor data request) can be used as a basis for forming the non-vehicle-specific sensor configuration request. As mentioned above, although the non-vehicle-specific sensor configuration request may include sensor configuration requests (or sensor data requests) that are particular to one or more vehicles, the format of the request may not be suitable for operative processing by the specified set of vehicles and, in this sense, the request is deemed “non-vehicle-specific.” The method 300 then ends.

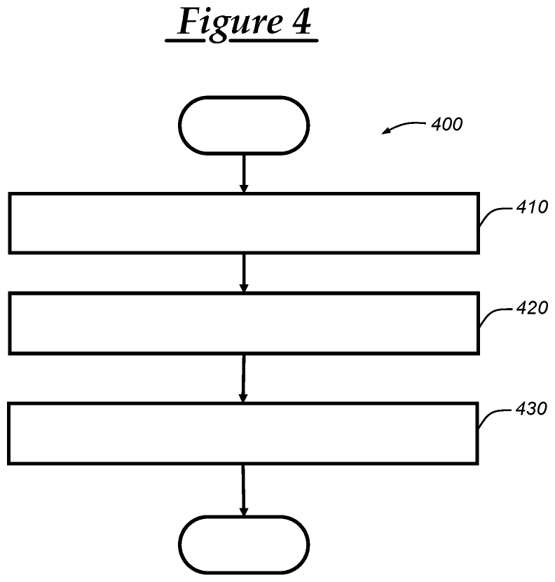

With reference to FIG. 4, there is shown an embodiment of a method 400 of remotely configuring vehicle electronics of one or more vehicles. In one embodiment, the method 400 can be carried out by the vehicle backend services server system 110 using the servers 112. In a particular embodiment, the method 400 can be executed as a part of the vehicle-specific sensor configuration application 118. In other embodiments, the method 400 can be carried out by the vehicle data request system 130, or parts thereof can be carried out by the vehicle data request system 130, the vehicle backend services server system 110, and/or other suitable electronic computing devices or systems. Although the steps of the method 400 are described as being carried out in a particular order, it is hereby contemplated that the steps of the method 400 can be carried out in any suitable order as will be appreciated by those skilled in the art. In one embodiment, the method 300 is carried out prior to method 400 and, in such a case, method 400 continues from method 300. For example, step 410 of method 400 is carried out after step 360 of method 300.

The method 400 begins with step 410, wherein a non-vehicle-specific sensor configuration request is received. In one embodiment, the non-vehicle-specific sensor configuration request is received at the vehicle backend system 110 from the vehicle data request system 130 as a result of the method 300 described above. In other embodiments, the non-vehicle-specific sensor configuration request can be received directly from one of the one or more vehicle sensor data requestors 78a-c. Once the non-vehicle-specific sensor configuration request is received, the request can be stored in memory 116 or databases 120. The method 400 continues to step 420.

In step 420, one or more vehicle-specific sensor configuration requests are generated based on the non-vehicle-specific sensor configuration request. As mentioned above, the non-vehicle-specific sensor configuration request can specify a particular set of vehicles that the request applies to or is to be applied to. Moreover, each of the vehicles within the specified set of vehicles can be associated with a particular vehicle electronics configuration type, which can differ among the vehicles within the specified set of vehicles. For example, the vehicle 12 may include a vehicle electronics configuration type A, while vehicles 14 and 16 include a vehicle electronics configuration type B. In at least one embodiment, a plurality of vehicle-specific sensor configuration requests can be generated from (or based on) a single non-vehicle-specific sensor configuration request, with each of the plurality of vehicle-specific sensor configuration requests including the vehicle sensor data request options in a form corresponding to a particular vehicle electronics configuration type. Thus, with reference to the previous example of the vehicle electronics configuration types, two vehicle-specific sensor configuration requests can be generated; one for vehicle electronics configuration type A (vehicle 12) and a second one for vehicle electronics configuration type B (vehicles 14, 16). In this way, each of the one or more vehicle-specific sensor configuration requests is associated with a particular vehicle electronics configuration type.

In one embodiment, this “generating” step can include or entail other steps, including, for example, determining a vehicle electronics configuration type for each of the vehicles within the specified set of vehicles; obtaining vehicle electronics reference information from the vehicle electronics reference information database 122; evaluating the vehicle electronics reference information in light of the non-vehicle-specific sensor configuration request, such as to determine which vehicle sensors of a particular vehicle electronics configuration type to configure and/or how to configure these vehicle sensors; and various other steps. For example, the non-vehicle-specific sensor configuration request may include a request for vehicle speed information without specifying a vehicle system module (VSM) or subsystem as a source for the vehicle speed information. In such a case, the generating step can include selecting one or more VSMs or vehicle subsystems to obtain the requested information (e.g., the vehicle speed information) based on the vehicle electronics reference information associated with the vehicle electronics configuration type. Thus, in many embodiments, the non-vehicle-specific sensor configuration request can be automatically converted into one or more vehicle-specific sensor configuration requests for the specified set of vehicles (e.g., as indicated in the vehicle sensor data request) without having to rely on the skills of a specialized vehicle electronics technician to specifically configure each of the vehicle-specific sensor configuration requests based on the associated vehicle electronics configuration type. In this way, users (e.g., vehicle data requestors) do not need specialized knowledge of various vehicle electronics configuration types when requesting vehicle sensor data or applying to modify vehicle electronics/sensor configurations. The method 400 then continues to step 430.

In step 430, the one or more vehicle-specific sensor configuration requests are sent to at least one of the specified set of vehicles. In many embodiments, these vehicle-specific requests are sent based on the particular vehicle electronics configuration type associated with each of the one or more vehicle-specific sensor configuration requests. For example, in a scenario where vehicle 12 is of a vehicle electronics configuration type A and vehicles 14,16 are of a vehicle electronics configuration type B, a first vehicle-specific sensor configuration request is sent to vehicle 12 and a second vehicle-specific sensor configuration request is sent to vehicle 14 and to vehicle 16. The first vehicle-specific sensor configuration request can thus be formatted or configured in a way that is particularly tailored for vehicles of vehicle electronics configuration type A, such as vehicle 12; likewise, the vehicle-specific sensor configuration request can thus be formatted or configured in a way that is particularly tailored for vehicles of vehicle electronics configuration type B, such as vehicle 14 and vehicle 16. In one embodiment, the vehicle-specific sensor configuration requests can include a vehicle electronics configuration script that, when executed by a processing device of the vehicle, causes the vehicle electronics to operate according to the vehicle sensor data request options (or the modified vehicle sensor data request options) that were included in the vehicle sensor data request (or the modified vehicle sensor data request) and/or according to the non-vehicle-specific sensor configuration request, as discussed in more detail below. The method 400 then ends.

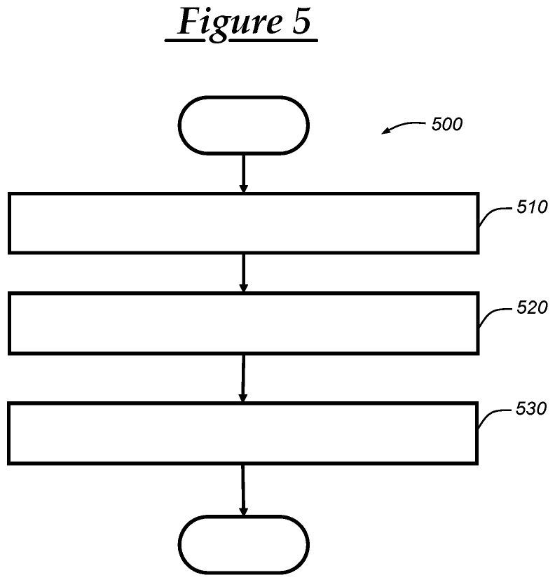

With reference to FIG. 5, there is shown an embodiment of a method 500 of remotely configuring vehicle electronics of one or more vehicles. In one embodiment, the method 500 can be carried out by the vehicle 12 using, for example, the wireless communications device 30. In a particular embodiment, the method 500 can be executed as a part of a vehicle sensor data configuration application that is stored on memory, such as memory 38, and executed by a processor (or other processing device), such as processor 36. Although the steps of the method 500 are described as being carried out in a particular order, it is hereby contemplated that the steps of the method 500 can be carried out in any suitable order as will be appreciated by those skilled in the art. In one embodiment, the method 400 is carried out prior to the method 500 and, in such a case, method 500 continues from method 400. For example, step 510 of method 500 is carried out after step 430 of method 400.

The method 500 begins with step 510, wherein a vehicle-specific sensor configuration request is received at a vehicle. The vehicle-specific sensor configuration request can be the first vehicle-specific sensor configuration request discussed above that is received at the vehicle 12. The vehicle-specific sensor configuration request can be formatted for, and/or configured to be processed by, a vehicle having a particular vehicle electronics configuration type, as discussed above. In one embodiment, the vehicle 12 can receive the vehicle-specific sensor configuration request using the wireless communications device 30. The vehicle-specific sensor configuration request can be sent by the vehicle backend services server system 110, which can establish a remote network connection with the vehicle 12 via land network 76 and/or cellular carrier system 70. In a particular embodiment, the connection between the vehicle backend system 110 and the vehicle 12 can be carried out using cellular communications over cellular carrier system 70 and, in such an embodiment, the vehicle 12 can use the wireless communications device 30, which can include the cellular chipset 34, and/or other VSM of the vehicle 12 that can carry out remote network connections, such as a telematics unit separate from the wireless communications device 30. In other embodiments, the vehicle-specific sensor configuration request can be sent to the vehicle 12 via land network 76 and the RSU 18 using any of the SRWCs discussed above. Other V2X (e.g., vehicle to infrastructure (V2I), vehicle to vehicle (V2V)) communication paths can be used as well. The method 500 continues to step 520.

In step 520, the vehicle is configured to operate according to the vehicle-specific sensor configuration request. In one embodiment, the vehicle-specific sensor configuration request can include a vehicle electronics configuration script that, when executed by the vehicle, causes the vehicle electronics to operate according to the vehicle sensor data request options (or the modified vehicle sensor data request options) that were included in the vehicle sensor data request (or the modified vehicle sensor data request) and/or according to the non-vehicle-specific sensor configuration request. Alternatively, or additionally, in other embodiments, the vehicle-specific sensor configuration request can include data representing all or a portion of the non-vehicle-specific sensor configuration request, the vehicle sensor data request options or the modified vehicle sensor data request options, other data in the vehicle sensor data request or the modified vehicle sensor data request, and/or other data, such as various metadata.

In one embodiment, the vehicle-specific sensor configuration request can include a vehicle electronics configuration script that is configured and/or compiled in a particular way according to, or based on, the particular vehicle electronics configuration type of the vehicle 12. The script can be executed by one or more vehicle system modules (VSMs) of the vehicle, including the wireless communications device 30, a separate or other telematics unit, another onboard computer, body control module (BCM) 24, etc. In a particular embodiment, the vehicle electronics configuration script can be configured and/or compiled according to, or based on, the vehicle electronics reference information, which is stored in the vehicle electronics reference information database 122 and which is associated with the particular vehicle electronics configuration type and/or the particular VSM communication architecture of the vehicle 12. And, in some embodiments, the vehicle-specific sensor configuration request can include a plurality of vehicle electronics configuration scripts that are to configured to be executed by various VSMs of the vehicle, including by various onboard vehicle sensors.

In some embodiments, the vehicle-specific sensor configuration request can include information that describes the requested vehicle sensor data, which can be, for example, the vehicle sensor data request options (or the modified vehicle sensor data request options). Once this information is received, a central control module of the vehicle, such as the wireless communications device 30, can either execute the vehicle electronics configuration script or can use information contained in the vehicle-specific sensor configuration request (e.g., vehicle sensor data request options) to otherwise configure the vehicle.

For example, the wireless communications device 30 can execute an application that is already installed on the vehicle (e.g., stored on memory 38 and ready for execution) and that takes information contained in the vehicle-specific sensor configuration request as input. This execution of the preconfigured vehicle application thereby causes the vehicle to comply with the requested vehicle sensor data configuration as indicated in the vehicle-specific sensor configuration request. In one embodiment, and with reference to Example 1, the vehicle 12 can store certain vehicle sensor data that is made available over the communications bus 40 during normal or typical vehicle use, query certain onboard vehicle sensors for certain requested vehicle sensor data, and/or monitor for the occurrence or triggering of certain vehicle conditions as specified in the vehicle-specific sensor configuration request.

The vehicle-specific sensor configuration request can cause the vehicle to be configured in a passive manner or an active manner. As used herein, a “passive manner” refers to vehicle electronics configurations that do not require altering the operation of the onboard vehicle sensor that is used by the vehicle to sense information. And, as used herein, an “active manner” refers to vehicle electronics configurations that do require altering the operation of the onboard vehicle sensor that is used by the vehicle to sense information. For example, a passive vehicle-specific sensor configuration request can include listening for the data over a communications bus (e.g., bus 40) and storing the data that is relevant to the vehicle-specific sensor configuration request. An example of an active vehicle-specific sensor configuration request can include querying the onboard vehicle sensors for certain requested vehicle sensor data and/or altering the sensing of one or more onboard vehicle sensors for purposes of complying with, or carrying out, the vehicle-specific sensor configuration request. The method 500 continues to step 530.

In step 530, the vehicle is operated in compliance with the vehicle-specific sensor configuration request. This can include a variety of actions, functions, or steps as specified in the vehicle-specific sensor configuration request discussed above. In one embodiment, the vehicle 12 can read and/or store vehicle sensor data from the communications bus 40. Moreover, the vehicle 12 can compile the relevant vehicle sensor data into one or more vehicle sensor data messages that are then sent over the cellular carrier system 70 and/or land network 76 to remote facility 80 (e.g., server systems 110, 130) and/or to the vehicle data requestors 78a-c. Or, these vehicle sensor data messages can be sent to the remote facility 80 and/or to the vehicle data requestors 78a-c via RSU 18 and land network 76. In another embodiment, the vehicle may modify settings or operations of one or more onboard vehicle sensors pursuant to the vehicle-specific sensor configuration request, such as by changing time(s) when the sensor operates to sense data, the frequency of data sensing, and/or other sensor settings. The method 500 then ends.

In one embodiment, the method 300, the method 400, the method 500, and/or parts thereof can be implemented in one or more computer programs (or “applications”, or “scripts”) embodied in a computer readable medium and including instructions usable (e.g., executable) by one or more processors of the one or more computers of one or more systems. The computer program(s) may include one or more software programs comprised of program instructions in source code, object code, executable code, or other formats. In one embodiment, any one or more of the computer program(s) can include one or more firmware programs and/or hardware description language (HDL) files. Furthermore, the computer program(s) can each be associated with any program related data and, in some embodiments, the computer program(s) can be packaged with the program related data. The program related data may include data structures, look-up tables, configuration files, certificates, or other relevant data represented in any other suitable format. The program instructions may include program modules, routines, programs, functions, procedures, methods, objects, components, and/or the like. The computer program(s) can be executed on one or more computers, such as on multiple computers that are in communication with one another.

The computer program(s) can be embodied on computer readable media (e.g., memory at servers 82, memory 38), which can be non-transitory and can include one or more storage devices, articles of manufacture, or the like. Exemplary computer readable media include computer system memory, e.g. RAM (random access memory), ROM (read only memory); semiconductor memory, e.g. EPROM (erasable, programmable ROM), EEPROM (electrically erasable, programmable ROM), flash memory; magnetic or optical disks or tapes; and/or the like. The computer readable medium may also include computer to computer connections, for example, when data is transferred or provided over a network or another communications connection (either wired, wireless, or a combination thereof). Any combination(s) of the above examples is also included within the scope of the computer-readable media. It is therefore to be understood that the method can be at least partially performed by any electronic articles and/or devices capable of carrying out instructions corresponding to one or more steps of the disclosed method.

It is to be understood that the foregoing is a description of one or more embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation. In addition, the term “and/or” is to be construed as an inclusive OR. Therefore, for example, the phrase “A, B, and/or C” is to be interpreted as covering all of the following: “A”; “B”; “C”; “A and B”; “A and C”; “B and C”; and “A, B, and C.”

1. A method of remotely configuring vehicle electronics of one or more vehicles, wherein the vehicle electronics includes one or more onboard vehicle sensors, the method comprising:
receiving a vehicle sensor data request from a vehicle sensor data requestor, wherein the vehicle sensor data request includes a request to obtain vehicle sensor data from a set of vehicles according to one or more vehicle sensor request options;
generating a non-vehicle-specific sensor configuration request based on the one or more vehicle sensor request options;
generating one or more vehicle-specific sensor configuration requests based on the non-vehicle-specific sensor configuration request, wherein each of the one or more vehicle-specific sensor configuration requests is associated with a particular vehicle electronics configuration type; and
sending each of the one or more vehicle-specific sensor configuration requests to one or more vehicles of the set of vehicles based on the particular vehicle electronics configuration type associated with each of the one or more vehicle-specific sensor configuration requests, wherein each of the one or more vehicles are configured to:
receive at least one of the vehicle-specific sensor configuration requests;
compile vehicle sensor data from one or more onboard vehicle sensors in response to receiving the at least one vehicle-specific sensor configuration request and based on the at least one vehicle-specific sensor configuration request; and
send the compiled vehicle sensor data to a remote computer or remote facility.

2. The method of claim 1, wherein the method is carried out using at least one computer program executing on at least one server located at a remote facility, and wherein the at least one computer program is stored on a non-transitory computer readable medium.

3. The method of claim 2, wherein the vehicle data requestor is a computer that is located remotely from the system carrying out the method.

4. The method of claim 1, wherein the one or more vehicle-specific sensor configuration requests are generated using vehicle electronics reference information stored in a database, wherein the database associates each of the particular vehicle electronics configuration types with particular vehicle electronics reference information.

5. The method of claim 1, wherein the vehicle sensor data request is received at a vehicle data request system, the non-vehicle-specific sensor configuration request is generated at the vehicle data request system, and the vehicle-specific sensor configuration requests are generated at a vehicle backend services server system.

6. The method of claim 5, further comprising the steps of:
sending the non-vehicle-specific sensor configuration request from the vehicle data request system to the vehicle backend services server system; and
receiving the non-vehicle-specific sensor configuration request at the vehicle backend services server system.

7. The method of claim 6, wherein the vehicle backend services server system includes a computer program that is configured to carry out the step of generating the one or more vehicle-specific sensor configuration requests and wherein the vehicle data request system includes a separate computer program that is configured to carry out the steps of receiving the vehicle sensor data request and generating the non-vehicle-specific sensor configuration request.

8. The method of claim 1, further comprising the steps of:
determining whether the vehicle sensor data request complies with a data privacy governance rule-set; and
denying the vehicle sensor data request when it is determined that the vehicle sensor data request does not comply with a data privacy governance rule-set.

9. The method of claim 8, further comprising the step of notifying the vehicle data requestor of the denial or approval of the vehicle sensor data request.

10. The method of claim 1, wherein the vehicle sensor data request includes vehicle sensor data request options specifying the set of vehicles.

11. The method of claim 10, wherein the one or more vehicle sensor request options include any one or more of the following: vehicle sensor data type(s), vehicle sensor data source(s), vehicle sensor collection frequency(s), and vehicle condition(s).

12. The method of claim 11, further comprising the steps of:
evaluating the vehicle sensor data request in conjunction with a plurality of active vehicle sensor configuration settings regarding the set of vehicles, wherein the vehicle sensor configuration settings indicate current settings of the one or more onboard vehicle sensors; and
determining redundancies in the vehicle sensor data request with respect to the active vehicle sensor configuration settings and based on the evaluating step;
wherein the non-vehicle-specific sensor configuration request is generated based at least partially on the determined redundancies in the vehicle sensor data request.

13. The method of claim 12, wherein modified vehicle sensor data request options are included in the non-vehicle-specific sensor configuration request, and wherein the modified vehicle sensor data request options are based on the determined redundancies in the vehicle sensor data request.

14. The method of claim 11, wherein the vehicle sensor data request specifies a particular time period for when the configuration of the one or more vehicles is to be effected.

15. The method of claim 1, wherein each of the one or more vehicles are further configured to modify operation of at least one of the one or more onboard vehicle sensors in response to the at least one vehicle-specific sensor configuration request.

16. The method of claim 1, wherein the at least one vehicle-specific sensor configuration request includes a vehicle electronics configuration script, wherein each of the one or more vehicles are further configured to execute the vehicle electronics configuration script, and wherein the execution of the vehicle electronics configuration script causes the vehicle to carry out the receive, compile, and send steps.

17. The method of claim 11, wherein a plurality of vehicle-specific sensor configuration requests are generated based on a single non-vehicle-specific sensor configuration request.

18. A remote vehicle sensor configuration system, comprising:
a first server that includes a processor and computer-readable memory, the computer-readable memory storing a vehicle request handling application;
a second server that includes a processor and computer-readable memory, the computer-readable memory storing a remote vehicle configuration application; and
a vehicle backend database that stores vehicle electronics reference information, wherein the vehicle electronics reference information is associated with one or more vehicle electronics configuration types;
wherein the vehicle request handling application, when executed by the processor of the first server, causes the first server to:
receive a vehicle sensor data request from a vehicle sensor data requestor, wherein the vehicle sensor data request includes a request to obtain vehicle sensor data from a set of vehicles according to one or more vehicle sensor request options;
generate a non-vehicle-specific sensor configuration request based on the one or more vehicle sensor request options; and
send the non-vehicle-specific sensor configuration request to the second server; and
wherein the remote vehicle configuration application, when executed by the processor of the second server, causes the second server to:
generate one or more vehicle-specific sensor configuration requests in response to receiving and based on the non-vehicle-specific sensor configuration request, wherein each of the one or more vehicle-specific sensor configuration requests is associated with a particular vehicle electronics configuration type, and wherein the vehicle electronics reference information associated with the particular vehicle electronics configuration type is used to generate the one or more vehicle-specific sensor configuration requests for vehicles of the particular vehicle electronics configuration type; and
send each of the one or more vehicle-specific sensor configuration requests to one or more vehicles of the set of vehicles based on the particular vehicle electronics configuration type associated with each of the one or more vehicle-specific sensor configuration requests.

19. The remote vehicle sensor configuration system of claim 18, wherein each of the one or more vehicles are configured to:
receive at least one of the vehicle-specific sensor configuration requests;
compile vehicle sensor data from one or more onboard vehicle sensors in response to receiving the at least one vehicle-specific sensor configuration request and based on the at least one vehicle-specific sensor configuration request; and
send the compiled vehicle sensor data to a remote computer or remote facility.

20. The remote vehicle sensor configuration system of claim 18, wherein the vehicle request handling application, when executed by the processor of the first server, further causes the first server to:
evaluate the vehicle sensor data request in conjunction with a plurality of active vehicle sensor configuration settings regarding the set of vehicles, wherein the vehicle sensor configuration settings indicate current settings of the one or more onboard vehicle sensors; and
determine redundancies in the vehicle sensor data request with respect to the active vehicle sensor configuration settings and based on the evaluating step;
wherein the non-vehicle-specific sensor configuration request is generated based at least partially on the determined redundancies in the vehicle sensor data request.
